(19) United States
(12) Patent Application Publication
(10) Pub. No.: US 2011/0291966 A1
(43) Pub. Date: Dec. 1, 2011

(54) TOUCH SCREEN DEVICE

(75) Inventors: Shigeyuki TAKAO, Fukuoka (JP); Seiji URANO, Fukuoka (JP); Akinori OSADA, Fukuoka (JP); Shinichi KITAMURA, Fukuoka (JP)

(73) Assignee: PANASONIC CORPORATION, Osaka (JP)

(21) Appl. No.: 13/115,335

(22) Filed: May 25, 2011

(30) Foreign Application Priority Data
May 28, 2010 (JP) 2010-122705

(51) Int. Cl. G06F 3/041

(52) U.S. Cl. 345/173

(57) ABSTRACT

According to the present invention, a touch screen device includes a first electrode having a plurality of first conductor lines, inclined at a predetermined angle in clockwise and counterclockwise directions with respect to a first direction and provided at a predetermined interval to form a grid-shaped pattern; and a second electrode having a plurality of second conductor lines, inclined at the predetermined angle in clockwise and counterclockwise directions with respect to a second direction, the second direction perpendicular to the first direction and provided at the predetermined interval to form a grid-shaped pattern. The first electrode and the second electrode are superimposed to form a pattern of squares as basic shapes, and the predetermined angle is greater than 0 degrees and less than 90 degrees. By superimposing the first electrode and the second electrode, a pattern of two different squares as basic shapes is formed due to interaction of the first electrode and the second electrode. In this manner, it is possible to inhibit the occurrence of moiré.

### CROSS-REFERENCE TO RELATED APPLICATIONS

The present application claims priority under 35 U.S.C. §119 of Japanese Application No. 2010-122705, filed on May 28, 2010, the disclosure of which is expressly incorporated by reference herein in its entirety.

### BACKGROUND OF THE INVENTION

1. Field of the Invention

The present invention relates to a touch screen device in which a touch surface is formed in a planar shape on a front surface side of a screen body having a flat-plate shape where an electrode is provided, and a user performs a touch operation on the touch surface with a pointing device such as the user's finger.

2. Description of Related Art

In a touch screen device, a touch surface is formed in a planar shape on a front surface side of a screen body having a flat-plate shape where an electrode is provided, and a user performs a touch operation on the touch surface with a pointing device such as the user's finger. The touch screen device is installed in a front surface of a display of a personal computer or an electronic device as a two-dimensional coordinate inputting unit.

As a touch screen device, there is known a capacitance type in which a position is detected based on variation in capacitance by bringing a finger into contact with or into close proximity thereto (see Related Art 1, for example). In the capacitance-type touch screen device, electrodes are provided to form a mesh pattern (e.g., squares). In the touch screen device, when a user's finger comes into contact with or into close proximity to the touch screen, capacitance is varied in an area where two electrodes intersect, and a position coordinate is calculated by detecting such variation in capacitance.

In the technology disclosed in Related Art1, mesh-patterned electrodes are provided only on one surface of a base. However, first electrodes arranged parallel with each other can be provided on one surface of a base and second electrodes arranged parallel with each other and perpendicular to the first electrodes can be provided on the other surface of the base. In this case, the first electrodes are superimposed on the second electrodes to form a square mesh pattern (Related Art 2).

In the technology disclosed in Related Art 2, however, there is a likelihood that interference fringes (a moiré pattern) will occur. Moiré refers to a fringe pattern that is caused by periodic displacement when repeating patterns are overlapped. The occurrence of moiré makes it difficult to see a displayed image of the display, and thereby deteriorates the visual operability or usability of the touch screen device. Categorized broadly, moiré may be low-frequency moiré in which large patterns consecutively appear, or high-frequency moiré in which small patterns consecutively appear. In particular, low-frequency moiré will make the display difficult to be viewed.

A continuous pattern of squares as a basic shape is unlikely to be recognized as a linear shape compared to other polygonal shapes, but the continuous pattern can not inhibit the occurrence of moiré.
Related Art 1: Japanese Patent Application Publication No. 2006-344163
Related Art 2: Japanese Patent Application Publication No. 2010-039537

### SUMMARY OF THE INVENTION

The present invention is provided to address such situation and circumstances that can occur in the conventional technologies. An objective of the present invention is to provide a touch screen device in which the occurrence of moiré is inhibited when electrodes are superimposed.

According to the present invention, a touch screen device includes a first electrode having a plurality of first conductor lines, inclined at a predetermined angle in clockwise and counterclockwise directions with respect to a first direction and provided at a predetermined interval to form a grid-shaped pattern; and a second electrode having a plurality of second conductor lines, inclined at the predetermined angle in clockwise and counterclockwise directions with respect to a second direction, the second direction perpendicular to the first direction and provided at the predetermined interval to form a grid-shaped pattern. The first electrode and the second electrode are superimposed to form a pattern of squares as basic shapes, and the predetermined angle is greater than 0 degrees and less than 90 degrees.

According to the present invention, by superposing the first electrode and the second electrode, a pattern of two different squares as basic shapes is formed due to interaction of the first electrode and the second electrode. In this manner, according to the present invention, it is possible to inhibit the occurrence of moiré.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic cross-sectional view illustrating a screen body of a touch screen device according to an embodiment of the present invention;

FIG. 2 is a plan view illustrating a configuration of first electrodes according to an embodiment;

FIG. 3 is an enlarged plan view of FIG. 2;

FIG. 4 is a plan view illustrating a configuration of second electrodes according to the embodiment;

FIG. 5 is an enlarged plan view of FIG. 4;

FIG. 6 is a plan view illustrating a configuration in which the first electrodes and the second electrodes are superimposed according to the embodiment;

FIG. 7 is an enlarged plan view of FIG. 6;

FIG. 8 is a plan view illustrating a configuration in which the first electrodes and the second electrodes are superimposed according to a reference example;

FIG. 9 is a simulation image when the reference example is attached to a display;

FIG. 10 is a simulation image when the embodiment is attached to a display;

FIG. 11 is a simulation image when a screen body having a predetermined angle θ of 0 degree is attached to a display;

FIG. 12 is a simulation image when a screen body having a predetermined angle θ of 5 degrees is attached to a display;

FIG. 13 is a simulation image when a screen body having a predetermined angle θ of 10 degrees is attached to a display;

FIG. 14 is a simulation image when a screen body having a predetermined angle θ of 15 degrees is attached to a display;

FIG. 15 is a simulation image when a screen body having a predetermined angle θ of 20 degrees is attached to a display;

FIG. 16 is a simulation image when a screen body having a predetermined angle θ of 25 degrees is attached to a display;

FIG. 17 is a simulation image when a screen body having a predetermined angle θ of 30 degrees is attached to a display;

FIG. 18 is a simulation image when a screen body having a predetermined angle θ of 35 degrees is attached to a display; and

FIG. 19 is a simulation image when a screen body having a predetermined angle θ of 40 degrees is attached to a display.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

The touch screen device, to which the present invention is applied, is used as a capacitance-type touch screen to be installed in a front surface of a display of a personal computer or an electronic device. A plurality of pixels are arranged in the display, and a black matrix is formed to define the pixels. The touch screen device has a screen body of a fiat-plate shape provided with a touch surface where a touch operation is performed by a user's finger; and a position detector (controller) that detects a touch position based on variation in capacitance corresponding to a touch operation performed by a finger on the touch surface. Hereinafter, an explanation will be provided of an embodiment of the screen body of the touch screen device according to the present invention with reference to the drawings.

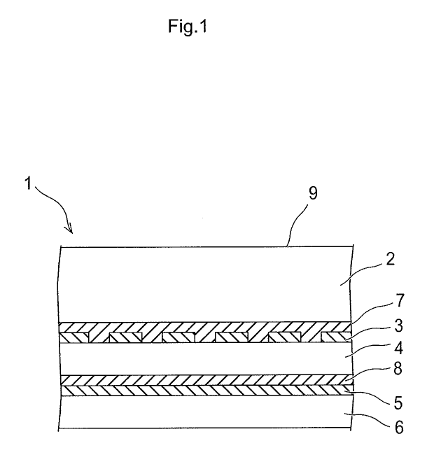

FIG. 1 is a schematic partial cross-sectional view illustrating a cross section of a screen body 1 in a thickness direction. The screen body 1 is considerably thin because the thickness is around several millimeters. In FIG. 1, however, the thickness of the screen body 1 is enlarged and schematically illustrated for the purpose of enhancing explanation.

Seen from a side attached to a display (not shown in the drawing), the screen body 1 has a second electrode base 6; a first electrode base 4 that is superimposed on the second electrode base 6 by an adhesive 8; and a screen base material 2 that is attached to the first electrode base 4 by an adhesive 7.

First electrodes 3 are provided on a surface of the first electrode base 4 opposite to the second electrode base 6. Second electrodes 5 are provided on the second electrode base 6 on the side of the first electrode base 4.

A transparent insulating material is used for the screen base material 2. Examples of the transparent insulating material include, as non-limiting examples, glass, transparent resin such as polyethylene (PE), polycarbonate (PC), polystyrene (PS), polyvinyl chloride (PVC), nylon/polyamide (PA), acrylic (PMMA), polypropylene (PP), polyimide (PI), acrylonitrile styrene copolymer (AS), and polyethersulfone (PES). The thickness of the screen base material 2 is 0.1-5 mm in the case of glass, and the relative permittivity is 2-10 in this case.

A surface of the screen base material 2 opposite to the first electrode base 4 serves as a touch surface 9 where a touch operation is performed by a user's finger. The adhesive 7 between the screen base material 2 and the first electrode base 4 is formed by coating and the like to protect the first electrodes 3. For example, an acrylic-based transparent adhesive can be used.

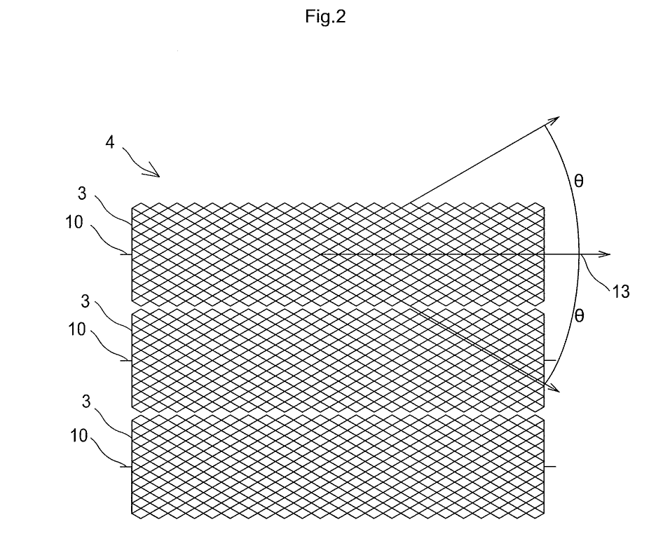

In addition, with reference to FIG. 2, the plural first electrodes 3, arranged in parallel with respect to each other, are formed on the first electrode base 4 at a predetermined interval. In FIG. 2, only three of the first electrodes 3 are illustrated for the purpose of explanation. Terminals 10 are formed at the ends of the first electrodes 3. The terminals 10 are connected to a position detector (not shown in the drawing).

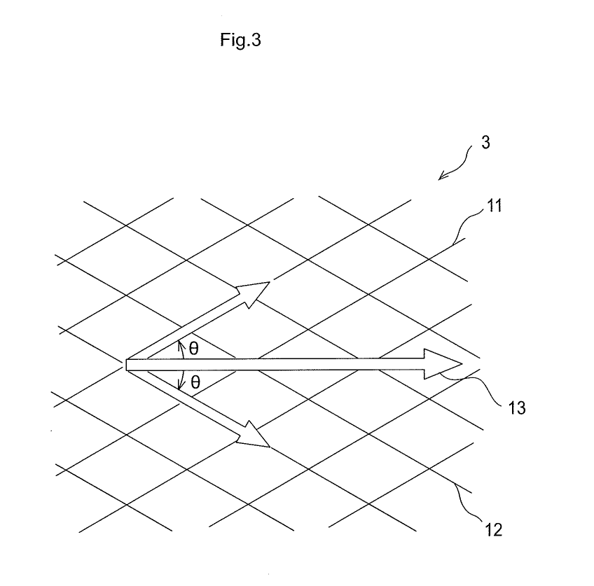

With reference to FIG. 3 in addition, a plurality of conductor lines 11 and 12, inclined at a predetermined angle θ in clockwise and counterclockwise directions with respect to a first direction 13 (horizontal direction of pixels in the display) connecting the terminals 10, are provided at a predetermined interval, and thereby the first electrodes 3 form a continuous pattern of rhombus shaped grids having an apex angle 2θ and configured by the conductor lines 11 and 12.

A conductive material is used to form the first electrodes 3. Examples of the conductive material include a conductive ink containing a metal material such as silver, gold, copper, aluminum, platinum or palladium, or metal particles thereof and including combination thereof, as non-limiting examples. In the first electrodes 3, the conductor lines 11 and 12 can be formed by a printing process and the like on the first electrode base 4. For example, gravure printing, screen printing, ink jet, photolithography, and the like, as non-limiting examples, can be used. As shown in FIG. 3, the figure is illustrated as if the two conductor lines 11 and 12 having a different angle are intersected in a planar view. However, the conductor lines 11 and 12 are formed by a printing process and the like, as described above, and in each one of the first electrodes 3 all are electrically conductive. When silver paste is used to form the conductor lines 11 and 12, the width may be 5-50 μm and the thickness may be 2-20 μm, for example. In this case, the volume resistance is 1×10⁻⁴ Ω·cm-1×10⁻⁵ Ω·cm, and wiring resistance is 50Ω-1 kΩ.

A transparent insulating material is used for the first electrode base 4. Examples of the transparent insulating material include transparent resin such as polyethylene terephthalate (PET), polyethylene (PE), polycarbonate (PC), polystyrene (PS), polyvinyl chloride (PVC), nylon/polyamide (PA), acrylic (PMMA), polypropylene (PP), polyimide (PI), acrylonitrile styrene copolymer (AS), and polyethersulfone (PES). The thickness of the first electrode base 4 is 0.05-2 mm in a case of a PET film, and the relative permittivity is 2.5-5.

The adhesive 8 between the first electrode base 4 and the second electrode base 6 is formed by coating and the like to protect the second electrodes 5. For example, an acrylic-based transparent adhesive, the same as or different than the adhesive, can be used.

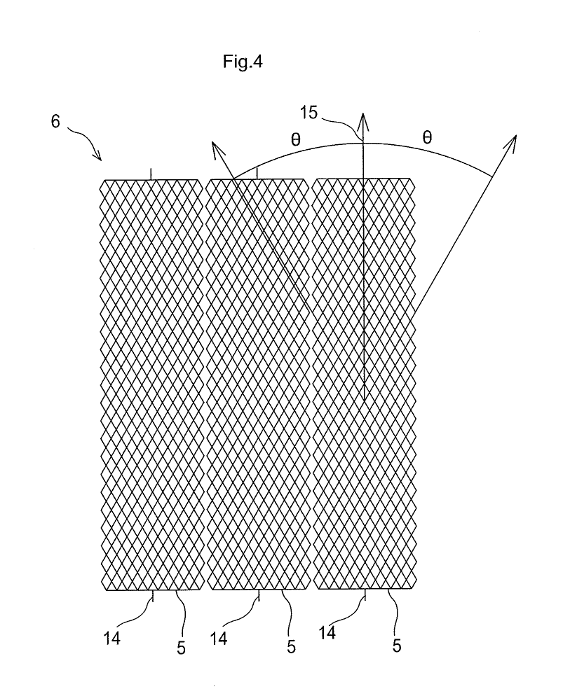

Next, with reference to FIG. 4, the plural second electrodes 5, arranged in parallel with respect to each other, are formed on the second electrode base 6 at a predetermined interval. Terminals 14 are formed at the ends of the second electrodes 5 so as to orthogonally cross the position of the terminals 10 of the first electrodes 3. In FIG. 4, in the same manner as FIG. 2, only three of the second electrodes 5 are illustrated for the purpose of explanation.

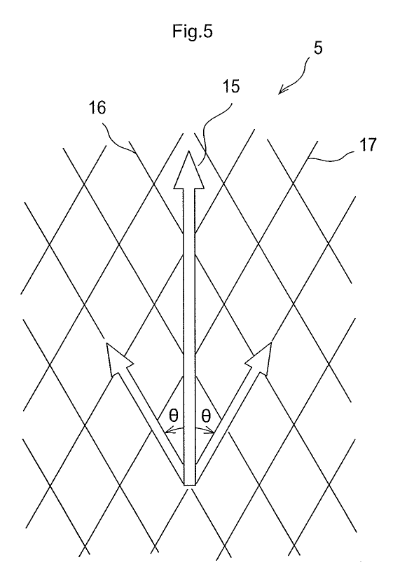

With reference to FIG. 5 in addition, a plurality of conductor lines 16 and 17, inclined only at a predetermined angle θ in clockwise and counterclockwise directions with respect to a second direction 15 (vertical direction of pixels in the display) connecting the terminals 14 perpendicular to the first direction 13, are provided at a predetermined interval, and thereby the second electrodes 5 form a continuous pattern of rhombus shaped grids having an apex angle 2θ and configured by the conductor lines 16 and 17.

A conductive material can be used for the second electrodes 5 similar to the first electrodes 3. In a manner similar to the first electrodes 3, the conductor lines 16 and 17 can be formed by a printing process and the like on the second electrode base 6. As shown in FIG. 5, similar to FIG. 3, it is illustrated as if the two conductor lines 16 and 17 having a different angle are intersected in a planar view. However, the conductor lines 16 and 17 are formed by a printing process and the like as described above, and in each one of the second electrodes 5 all are electrically conductive.

A transparent insulating material may be used for the second electrode base 6 similar to the first electrode base 4. In the configuration of the present embodiment, the first electrodes 3 are formed on the first electrode base 4, and the second electrodes 5 are formed on the second electrode base 6. According to the present invention, however, the first electrodes 3 may be formed on a front surface of the first electrode base 4, and the second electrodes 5 may be formed on a rear surface of the first electrode base 4. In this configuration, the second electrode base 6 can be omitted, and the second electrodes 5, on the display side, are protected by coating with a protective insulating material.

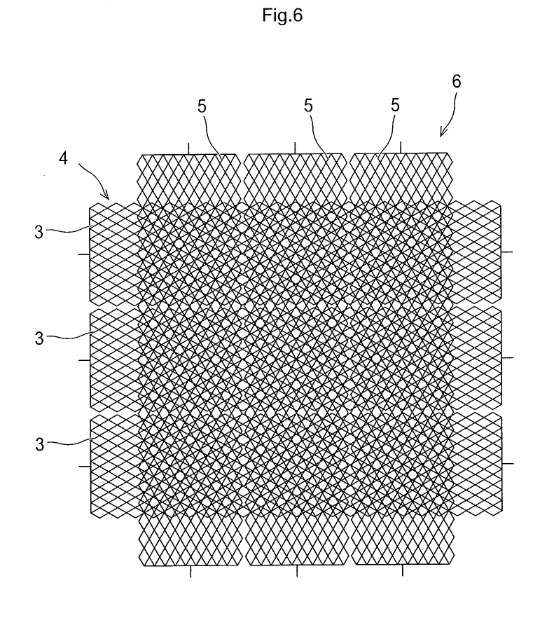

Next, with reference to FIG. 6, the first electrode base 4, on which the first electrodes 3 are formed, is superimposed on the second electrode base 6, on which the second electrodes 5 are formed, by the adhesive 8 (not shown in the drawing). The rhombus shaped grid pattern of the first electrodes 3 and the rhombus shaped grid pattern of the second electrodes 5 are overlapped so as to form a new pattern.

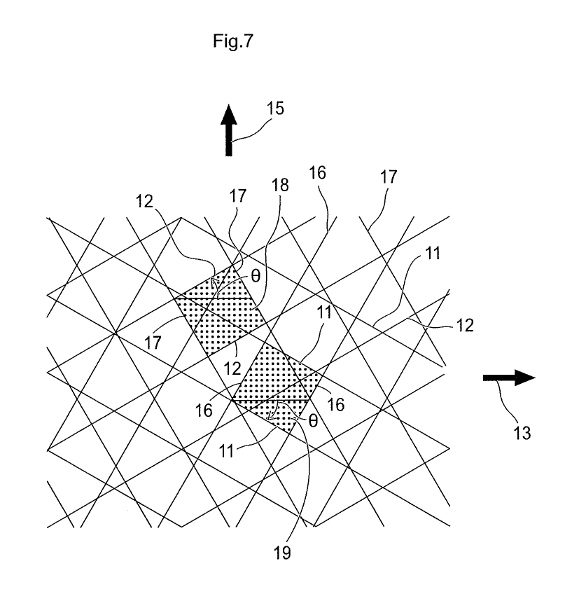

With reference to FIG. 7 in addition, the conductor lines 11 and 12 that configure or define the first electrodes 3 are superimposed on the conductor lines 16 and 17 that configure or define the second electrodes 5. The rhombus shaped grids formed by the conductor lines 11 and 12; and the rhombus shaped grids formed by the conductor lines 16 and 17 have the same shape, and they are rotated by 90 degrees with respect to each other. Consequently, the conductor line 11 and the conductor line 16 orthogonally cross, and the conductor line 12 and the conductor line 17 orthogonally cross.

When attention is paid to the intersections between the conductor line 11 and the conductor line 16; and to the intersections between the conductor line 12 and the conductor line 17, it can be seen that a square 18 is generated whose four sides are formed by the conductor line 12; the conductor line 17; the conductor line 12; and the conductor line 17, and a square 19 is generated whose four sides are formed by the conductor line 11; the conductor line 16; the conductor line 11; and the conductor line 16. The square 18 and the square 19 have the same size, and they are rotated only by a predetermined angle θ with respect to each other. A continuous pattern is formed by the squares 18 as the basic shape which are directed in a direction inclined at a predetermined angle θ counterclockwise with respect to the first direction 13 and in a direction inclined at a predetermined angle θ counterclockwise with respect to the second direction 15. Also, a continuous pattern is formed by the squares 19 as the basic shape which are directed in a direction inclined at a predetermined angle θ clockwise with respect to the first direction 13 and in a direction inclined at a predetermined angle θ clockwise with respect to the second direction 15.

According to the above-described configuration, the squares 18 and the squares 19 can be formed even when the positional relationship between the first electrodes 3 and the second electrodes 5 is displaced backward, forward, right, or left, for example, without a complicated combination.

A continuous pattern of squares as a basic shape is unlikely to be recognized as a linear shape compared to other polygonal shapes. Specifically, regarding a pattern having regularly continuous polygonal shapes other than squares as a basic shape, the profile tends to look like a continuous linear shape along a direction in which the basic shape (opening) continues. In a case of continuous pattern of squares as a basic shape, however, such a linear shape does not appear very much.

According to the present embodiment, the first electrodes 3 and the second electrodes 5, formed on the first electrode base 4 and the second electrode base 6 respectively, are superimposed, which forms a continuous pattern of two different squares as basic shapes, and an operator or user of the touch screen can visually observe the pattern. Specifically, according to the present embodiment, the pattern is formed due to interaction of the first electrodes 3 and the second electrodes 5, which makes it unlikely that the mesh pattern of the electrodes will be recognized as a linear shape compared to a pattern of one square as a basic shape. A linear-shaped pattern may cause low-frequency moiré. The present embodiment thus accordingly controls the occurrence of low-frequency moiré.

Also, as described above, the pattern of the first electrodes 3 and the pattern of the second electrodes 5 are formed by a printing process. Generally, it is difficult to eliminate registration error (position displacement) at the time of forming (i.e., printing) an electrode pattern, whether the first electrodes 3 and the second electrodes 5 are printed on different bases respectively and superimposed, or whether the first electrodes 3 and the second electrodes 5 are printed on a front surface and a rear surface of a single base.

According to the present embodiment, however, the continuous electrode pattern of two different squares as basic shapes, is formed uniformly on an entire surface of the screen due to interaction of the first electrodes 3 and the second electrodes 5. According to this configuration, even in a case where registration is displaced (misregistration occurs) at the time of forming an electrode pattern, a continuous pattern of squares as a basic shape is formed without interruption, which makes it possible to reduce both moiré due to the electrode pattern itself, and interference with arrangement of pixels in a display.

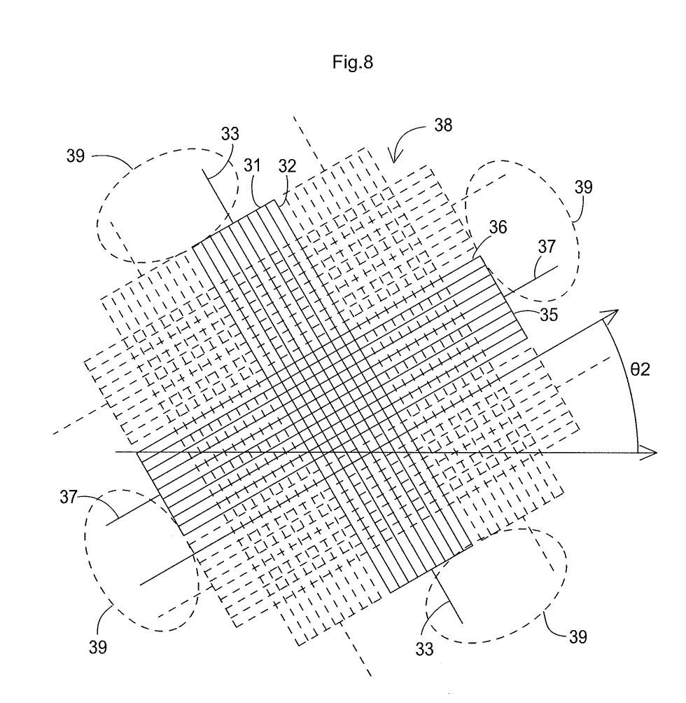

Next, with reference to FIGS. 8-10, a comparison will be made between a reference example in which moiré is controlled by an electrode configuration of a conventional technology and the embodiment of the present invention. In the comparison, an explanation will be provided for a case where a touch screen body is attached to a display in which pixels of rectangular grids are arranged in a horizontal direction and a vertical direction.

With reference to FIG. 8, in the electrode configuration of the conventional technology of the reference example, a first electrode 31 is configured with two terminals 33 and a plurality of conductor lines 32 that connect the two terminals 33 and are arranged in parallel. The first electrode 31 is formed on a base (not shown in the drawing) by a printing process and the like. A second electrode 35 is configured with two terminals 37 and a plurality of conductor lines 36 that connect the two terminals 37 and are arranged in parallel. The second electrode 35 is formed on the base by a printing process and the like in the same manner as the first electrode 31.

The first electrode 31 and the second electrode 35 are superimposed, such that the conductor lines 32 and the conductor lines 36 are orthogonally crossed in a planar view while being insulated from each other, so as to form a screen body 38. The screen body 38 is attached to a display (not shown in the drawing) in a state where the bias angle θ2 is inclined by 30 degrees so as to prevent an occurrence of moiré due to interaction between the pixels arranged in the horizontal direction and the vertical direction in the display. Since the first electrode 31 and the second electrode 35 are already formed on the screen body 38, the bias angle θ2 is the inclination of the conductor lines 36 of the second electrode 35 with respect to the horizontal direction of the drawing, and the inclination of the conductor lines 32 of the first electrode 31 with respect to the vertical direction of the drawing. In this configuration, the conductor lines 32 and the conductor lines 36 are superimposed so as to form an electrode pattern in which squares as a basic shape continue.

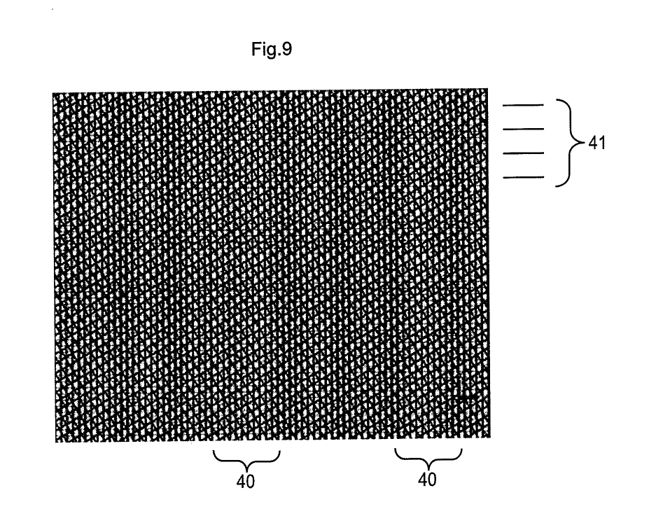

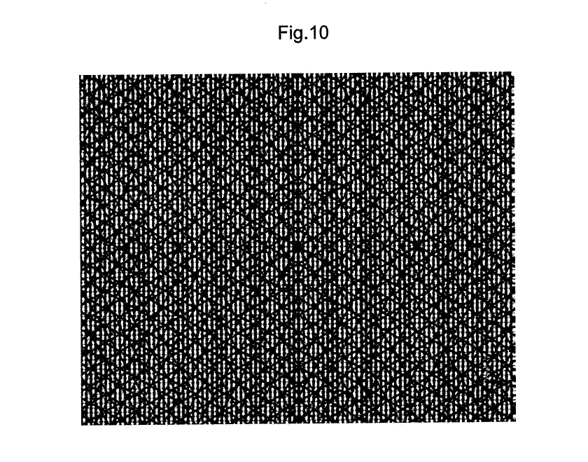

Next, with reference to FIGS. 9 and 10, FIG. 9 is a simulation image when the screen body 38 of the reference example is attached to a display, and FIG. 10 is a simulation image when the screen body of the embodiment is attached to a display. In the embodiment, the screen body 1 explained in FIGS. 1, 6, and 7 is used, and the predetermined angle θ is 30 degrees the same as the bias angle θ2 of the reference example.

As shown in FIG. 9, in the reference example, low-frequency moiré 40 occurs in the vertical direction, and low-frequency moiré 41 occurs in the lateral direction. In contrast, in the embodiment shown in FIG. 10, there is no especially conspicuous low-frequency moiré.

Referring back to FIG. 8 which shows the reference example, since the screen body 38 is merely rotated by the bias angle θ2 in the reference example, the terminals 33 and the terminals 37 in a direction of electrical connection are also rotated, so as to cause four corners 39 in which no electrode of the screen body 38 is formed. It is difficult to wire a conductor line to the corners 39. Even if a conductor line is wired, the wiring length of the electrodes to be detected becomes different, which may complicate signal processing (such as correction). In this manner, the reference example may cause waste of space.

On the other hand, the embodiment does not cause the situation of the reference example with regard to the electrode wiring and the like, and the occurrence of moiré can be inhibited. According to the embodiment, as compared to the reference example, the screen body does not need a complicated configuration, and it is easily attached to a display. Consequently, the cost is reduced, and usability is improved.

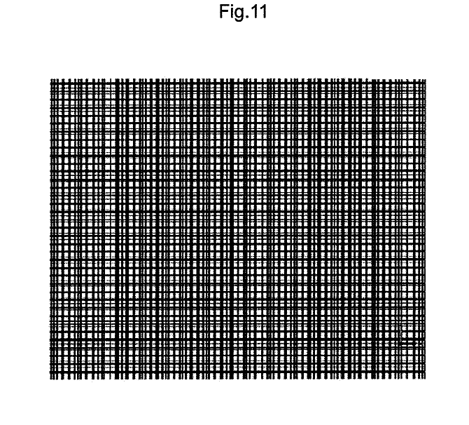

Next, with reference to FIGS. 11-19, an explanation will be provided regarding a state of a screen when the predetermined angle θ is varied. FIGS. 11-19 are a simulation images when a screen body is attached to a display in which pixels of rectangular grids are arranged in a horizontal direction and in a vertical direction.

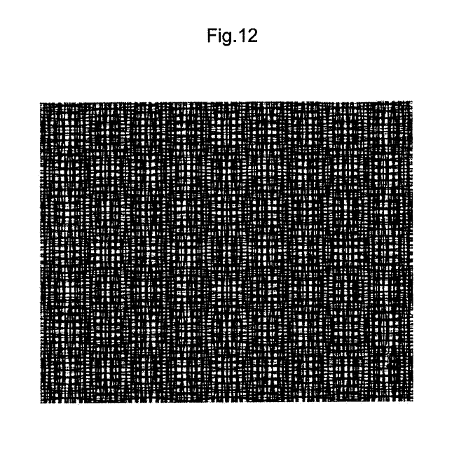

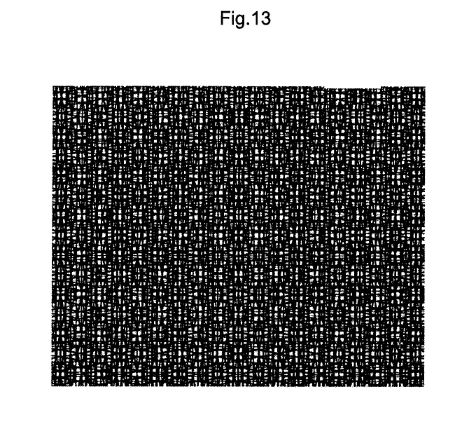

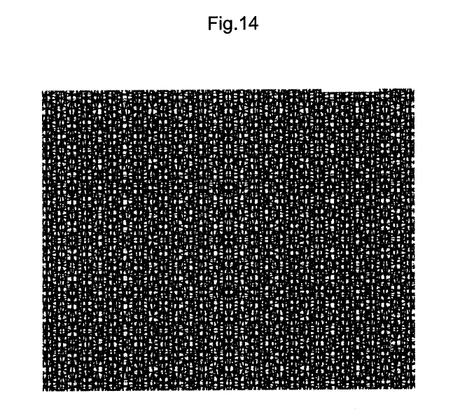

FIG. 11 shows a case where the predetermined angle θ is 0 degrees. In this case, moiré is observed between the pixels of the display. FIG. 12 shows a case where the predetermined angle θ is 5 degrees, FIG. 13 shows a case where the predetermined angle θ is 10 degrees, and FIG. 14 shows a case where the predetermined angle θ is 15 degrees. In these cases, the occurrence of conspicuous moiré between the pixels of the display, such as in the case where the predetermined angle θ is 0 degrees, is inhibited. However, high-frequency fine moiré is observed. The size of moiré which occurs is reduced as the predetermined angle becomes larger.

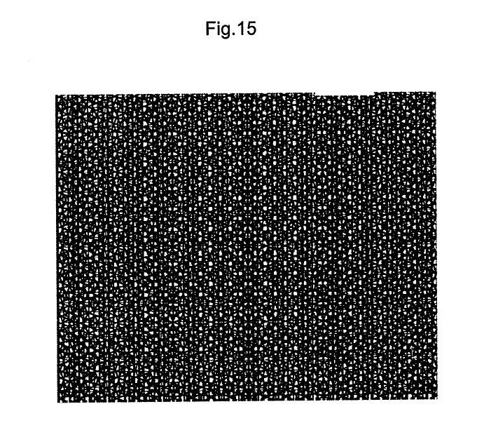

FIG. 15 shows a case where the predetermined angle θ is 20 degrees. In this case, low-frequency large moiré is not observed, however, high-frequency moiré is observed that is even finer than the cases where the predetermined angle θ is 0-15 degrees.

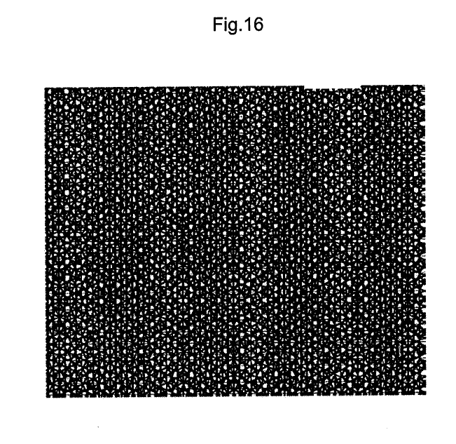

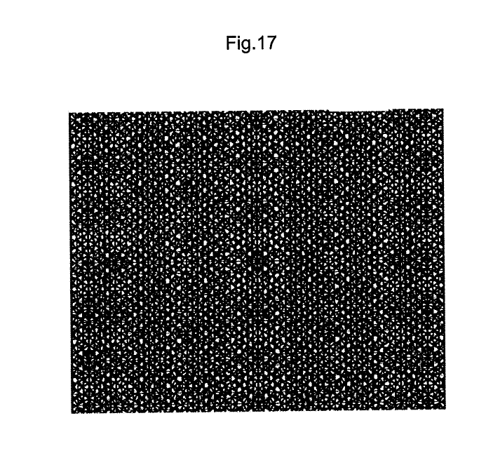

FIG. 16 shows a case where the predetermined angle θ is 25 degrees, and FIG. 17 shows a case where the predetermined angle θ is 30 degrees. In these cases, there is almost no conspicuous moiré compared to the cases where the predetermined angle θ is 20 degrees or less.

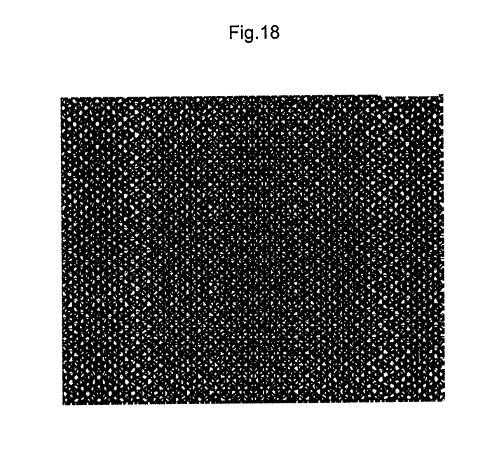

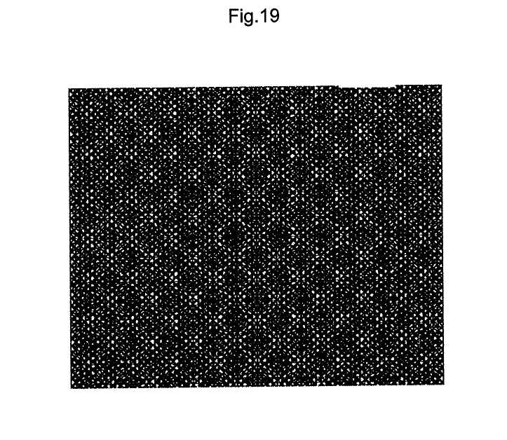

FIG. 18 shows a case where the predetermined angle θ is 35 degrees. In this case, some low-frequency moiré is observed compared to the cases where the predetermined angle θ is 25 degrees, and the predetermined angle θ is 30 degrees. However, it is not so conspicuous. FIG. 19 shows a case where the predetermined angle θ is 40 degrees. In this case, some low-frequency moiré is observed compared to the cases where the predetermined angle θ is 20-35 degrees.

From the simulation results described above, regarding selection of the predetermined angle θ in the present invention, it is preferable that the predetermined angle θ is 20-35 degrees in which the visibility of the image on the display is not deteriorated as a whole although some high-frequency moiré is observed. It is more preferable that the predetermined angle θ is 25-30 degrees in which almost no high-frequency moiré is visible. Incidentally, an explanation is omitted for cases where the predetermined angle θ is 50-85 degrees because the same simulation images are obtained as the cases where the predetermined angle θ is 5-40 degrees due to the relationship between the first electrodes and the second electrodes orthogonally crossed with each other.

As described above, according to the present invention, by selecting the predetermined angle θ appropriately, it is possible to form patterns of squares in which the mesh pattern of the electrodes is unlikely to be recognized as a linear shape compared to other polygonal shapes. Consequently, it is possible to inhibit the occurrence of moiré, especially low-frequency moiré.

The touch screen device of the present invention has an effect that inhibits the occurrence of moiré when the first electrode and the second electrode are superimposed, and in particular inhibits the occurrence of low-frequency moiré. The touch screen device of the present invention is useful as a touch screen device, and the like, in which a touch surface is formed in a planar shape on a front surface side of a screen body having a flat-plate shape provided with an electrode and a user performs a touch operation to the touch surface by a pointing device such as the user's finger.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A touch screen device comprising:
a first electrode having a plurality of first conductor lines, inclined at a predetermined angle in clockwise and counterclockwise directions with respect to a first direction and provided at a predetermined interval to form a grid-shaped pattern; and
a second electrode having a plurality of second conductor lines, inclined at the predetermined angle in clockwise and counterclockwise directions with respect to a second direction, the second direction perpendicular to the first direction and provided at the predetermined interval to form a grid-shaped pattern,
wherein the first electrode and the second electrode are superimposed to form a pattern of squares as basic shapes, and
the predetermined angle is greater than 0 degrees and less than 90 degrees.

2. The touch screen device according to claim 1, wherein the predetermined angle is within a range of between 20 degrees and 35 degrees.

3. The touch screen device according to claim 2, wherein the predetermined angle is within a range of between 25 degrees and 30 degrees.

4. The touch screen device according to claim 1, wherein the first direction is a horizontal direction of pixels in a display.

5. The touch screen device according to claim 1, wherein the touch screen device further comprises a base,
wherein the first electrode is formed on a first surface of the base and the second electrode is formed on a second surface that is opposite the first surface.

6. The touch screen device according to claim 5, wherein the base comprises an insulating material.

7. The touch screen device according to claim 5, wherein the base comprises a transparent material.

8. The touch screen device according to claim 1, wherein the touch screen device further comprises a first base; and a second base superimposed on the first base,
wherein the first electrode is formed on a surface of the first base opposite the second base, and the second electrode is formed on a surface of the second base facing the first base.

9. The touch screen device according to claim 8, wherein the first base comprises an insulating material.

10. The touch screen device according to claim 8, wherein the first base comprises a transparent material.

11. The touch screen device according to claim 8, wherein the second base comprises an insulating material.

12. The touch screen device according to claim 8, wherein the second base comprises a transparent material.

13. The touch screen device according to claim 1, wherein a plurality of first electrodes are arranged parallel to each other.

14. The touch screen device according to claim 13, wherein a plurality of second electrodes are arranged parallel to each other in a direction perpendicular to a direction in which the first electrodes are arranged.

15. The touch screen device according to claim 8, wherein a screen base material is attached to the first base.

16. The touch screen device according to claim 1, wherein the plurality of first conductor lines define a continuous pattern of rhombus shaped grids.

17. The touch screen device according to claim 1, wherein the plurality of second conductor lines define a continuous pattern of rhombus shaped grids.

18. The touch screen device according to claim 1, wherein each of the plurality of first conductor lines and second conductor lines define a continuous pattern of rhombus shaped grids, a plurality of first electrodes each having a plurality of the first conductor lines are arranged parallel to each other and extending in a first direction, and a plurality of second electrodes each having a plurality of second conductor lines are arranged parallel to each other and extending in a second direction perpendicular to the first direction, one of the first and second plurality of electrodes overlying the other of the first and second plurality of electrodes.

19. The touch screen device according to claim 18, further comprising a base, said plurality of first electrodes being provided on a first surface of said base and said plurality of second electrodes being provided on a second surface of said base that is opposite to said first surface of said base.

20. The touch screen device according to claim 18, further comprising a first base and a second base superimposed on the first base, said plurality of first electrodes are provided on a surface of the first base opposite to the second base and the plurality of second electrodes are provided on a surface of the second base facing the first base.
